(19) United States
(12) Patent Application Publication
(10) Pub. No.: US 2025/0028906 A1
(43) Pub. Date: Jan. 23, 2025

(54) LANGUAGE PROCESSING APPARATUS, IMAGE PROCESSING METHOD, AND PROGRAM

(71) Applicant: NIPPON TELEGRAPH AND TELEPHONE CORPORATION, Tokyo (JP)

(72) Inventors: Kosuke NISHIDA, Tokyo (JP); Kyosuke NISHIDA, Tokyo (JP); Sen YOSHIDA, Tokyo (JP)

(21) Appl. No.: 18/714,320

(22) PCT Filed: Dec. 6, 2021
(86) PCT No.: PCT/JP2021/044790

§ 371 Date: May 29, 2024

(51) Int. Cl. G06F 40/284; G06N 3/0895

(52) U.S. Cl. CPC G06F 40/284; G06N 3/0895

(57) ABSTRACT

A language processing device includes a hardware processor configured to extract a feature amount from text data based on model parameters of a neural network; output an answer start point score, an answer end point score, and an answer possibility score using the feature amount as an input, based on model parameters of the neural network; extract predetermined n answer suitability scores based on the answer start point score and the answer end point score; obtain n adjusted answer suitability scores from the n answer suitability scores and obtain an adjusted answer possibility score from the answer possibility score, based on model parameters of the neural network; and lean the model parameters based on the n adjusted answer suitability scores, the adjusted answer possibility score, a correct answer section, and a correct answer possibility.

### TECHNICAL FIELD

The content of the present disclosure relates to a language processing device, an image processing method, and a program.

### BACKGROUND ART

A task of answering a question from a user by extracting a section of a text while referring to the text (character information) written in natural language is called extraction-type machine reading. The extraction-type machine reading is generally solved by an identification-type deep learning model such as bidirectional encoder representations from transformers (BERT) (Non Patent Literature 1). SQuAD 2.0 is a typical data set of the extraction-type machine reading (Non Patent Literature 2).

As a representative example in which the identification-type deep learning model is used, there is a task of receiving an image on which one number from 0 to 9 is written and outputting a correct label (a number in this case). In the identification-type deep learning model, a probability distribution using a label set as a table can be output as a probability that each label is true. Here, the “table” is a set of values that can be taken by a random variable. The label set is 10 numbers from 0 to 9. The “probability that each label is true” can be paraphrased as reliability of prediction.

In the identification-type deep learning model for the extraction-type machine reading, the label set is a set of positions of texts. That is, assuming that a text length is L, {1, . . . , L} is the label set. By selecting a start point and an end point of a section to be extracted from the label set, one section to be extracted can be determined. Further, it is also possible to prepare a label of {answer impossibility, answer possibility} in order to consider answer possibility. In this way, preparing two or three classifiers for the start point, the end point, and the answer possibility is a feature of the identification-type deep learning model for the extraction-type machine reading.

### CITATION LIST

### Non Patent Literature

Non Patent Literature 1: BERT: Pre-training of Deep Bidirectional Transformers for Language Understanding Non Patent Literature 2: Know What You Don't Know: Unanswerable Questions for SQuAD

### SUMMARY OF INVENTION

### Technical Problem

However, it is generally known that a deep learning model has a problem of overconfidence. That is, a probability p(m) that a label m which is output from an identification-type deep learning model is true tends to be higher than a probability that m is actually true. This overconfidence phenomenon is a big problem when reliability of output is presented to a user.

The present invention has been made in view of the above points, and an object of the present invention is to more appropriately calculate reliability of prediction as compared with the technique in the related art.

### Solution to Problem

In order to solve the above problems, according to the invention of claim 1, there is provided a language processing device including: a language understanding unit that extracts a feature amount from text data; a feature amount conversion unit that receives the feature amount as an input and outputs an answer start point score, an answer end point score, and an answer possibility score; an n-best extraction unit that extracts predetermined n answer suitability scores based on the answer start point score and the answer end point score; and an adjustment unit that obtains n adjusted answer suitability scores from the n answer suitability scores, and obtains an adjusted answer possibility score from the answer possibility score, in which the language understanding unit, the feature amount conversion unit, and the adjustment unit perform processing based on model parameters of a neural network, and perform learning of the model parameters based on the n adjusted answer suitability scores, the adjusted answer possibility score, a correct answer section, and a correct answer possibility.

### Advantageous Effects of Invention

As described above, the present invention has an effect that the reliability of prediction can be more appropriately calculated as compared with the technique in the related art.

### BRIEF DESCRIPTION OF DRAWINGS

FIG. 1 is a schematic diagram of a communication system according to the present embodiment.

FIG. 2 is a hardware configuration diagram of a language processing device and a communication terminal.

FIG. 3 is a functional configuration diagram of a learning phase of training data of the language processing device.

FIG. 4 is a functional configuration diagram of a learning phase of development data of the language processing device.

FIG. 5 is a functional configuration diagram of an inference phase of test data of the language processing device.

FIG. 6 is a flowchart illustrating processing of a learning phase of training data.

FIG. 7 is a flowchart illustrating processing of a learning phase of development data.

FIG. 8 is a flowchart illustrating processing of an inference phase of test data.

FIG. 9 is a diagram illustrating evaluation results.

### DESCRIPTION OF EMBODIMENTS

Hereinafter, an embodiment of the present invention will be described with reference to the drawings.

### System Configuration According to Embodiment

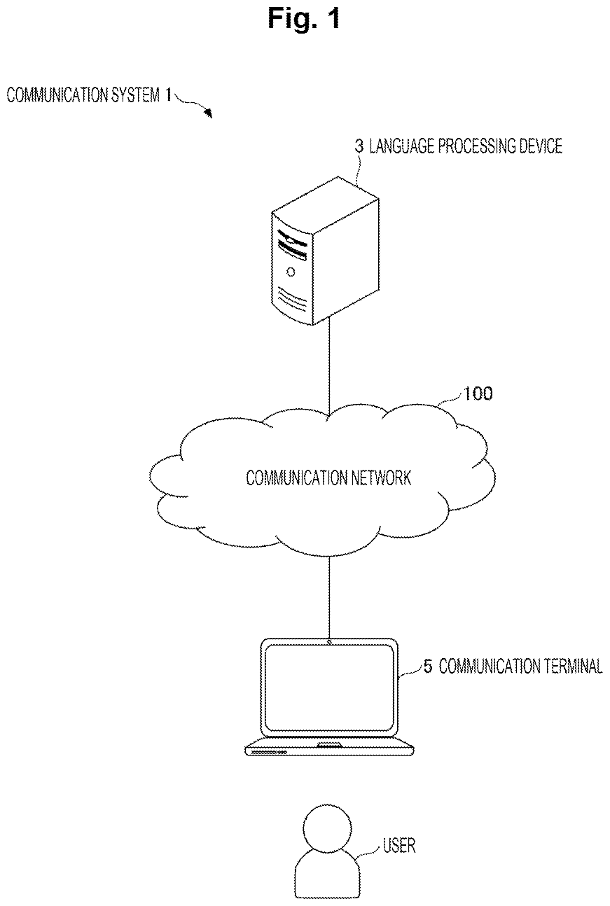

First, an outline of a configuration of a communication system 1 according to the present embodiment will be described with reference to FIG. 1. FIG. 1 is a schematic diagram of a communication system according to the embodiment of the present invention.

As illustrated in FIG. 1, a communication system 1 according to the present embodiment is configured with a language processing device 3 and a communication terminal 5. The communication terminal 5 is managed and used by a user.

In addition, the language processing device 3 and the communication terminal 5 can communicate with each other via a communication network 100 such as the Internet. The connection form of the communication network 100 may be either wireless or wired.

The language processing device 3 is configured with one or a plurality of computers. In a case where the language processing device 3 is configured with a plurality of computers, the language processing device 3 may be referred to as a “language processing device” or a “language processing system”.

The language processing device 3 is a computer, and is a device that more appropriately calculates reliability of prediction (inference) in a case where a deep learning model is used. In addition, the language processing device 3 outputs result data that is a result of prediction. Examples of the output method include displaying or printing a graph or the like related to the result data on the communication terminal 5 side by transmitting the result data to the communication terminal 5, displaying the graph or the like on a display connected to the language processing device 3, and printing the graph or the like by a printer or the like connected to the language processing device 3.

The communication terminal 5 is a computer. FIG. 1 illustrates a notebook personal computer as an example. On the other hand, the communication terminal 5 is not limited to a notebook type, and may be a desktop personal computer. Further, the communication terminal may be a smartphone or a tablet terminal. In FIG. 1, the user operates the communication terminal 5.

### [Hardware Configuration of Language Processing Device and Communication Terminal]

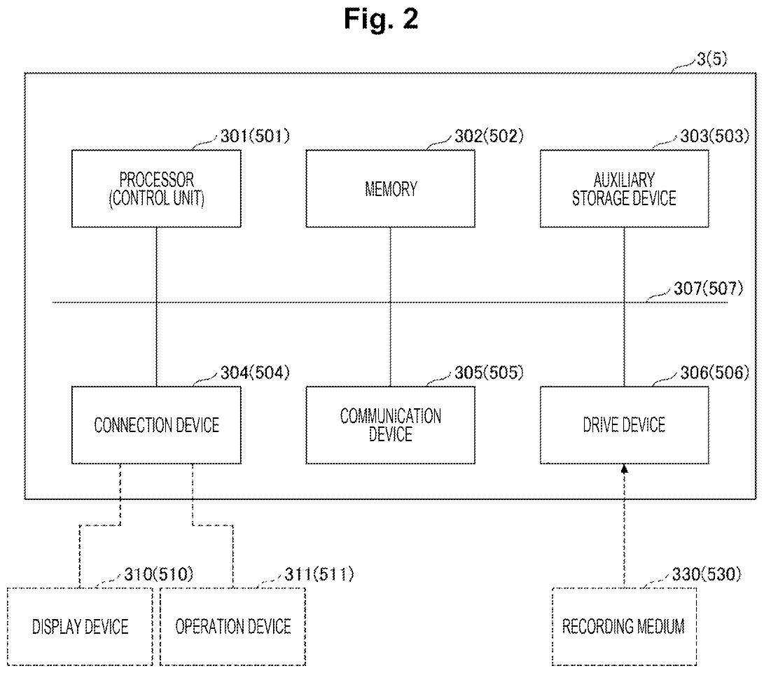

Next, a hardware configuration of the language processing device 3 and the communication terminal 5 will be described with reference to FIG. 2. FIG. 2 is a hardware configuration diagram of the language processing device and the communication terminal.

As illustrated in FIG. 2, the language processing device 3 includes a processor 301, a memory 302, an auxiliary storage device 303, a connection device 304, a communication device 305, and a drive device 306. Note that hardware components of the language processing device 3 are connected to each other via a bus 307.

The processor 301 serves as a control unit that controls the entire language processing device 3, and includes various arithmetic devices such as a central processing unit (CPU). The processor 301 reads various programs on the memory 302 and executes the programs. Note that the processor 301 may include general-purpose computing on graphics processing units (GPGPU).

The memory 302 includes a main storage device such as a read only memory (ROM) and a random access memory (RAM). The processor 301 and the memory 302 configure a so-called computer. The processor 301 executes various programs read on the memory 302, and thus the computer implements various functions.

The auxiliary storage device 303 stores various programs and various types of information used when the various programs are executed by the processor 301.

The connection device 304 is a connection device that connects an external device (for example, a display device 310 or an operation device 311) and the language processing device 3.

The communication device 305 is a communication device for transmitting and receiving various types of information to and from another device.

The drive device 306 is a device for setting a recording medium 330. The recording medium 330 described here includes a medium that optically, electrically, or magnetically records information, such as a compact disc read-only memory (CD-ROM), a flexible disk, or a magneto-optical disk. Further, the recording medium 330 may include a semiconductor memory or the like that electrically records information, such as a read only memory (ROM) or a flash memory.

Note that, for example, in a case where the distributed recording medium 330 is set in the drive device 306 and the various programs recorded in the recording medium 330 are read by the drive device 306, the various programs to be installed in the auxiliary storage device 303 are installed. Alternatively, the various programs to be installed in the auxiliary storage device 303 may be installed by being downloaded from a network via the communication device 305.

In addition, FIG. 2 illustrates a hardware configuration of the communication terminal 5. Since each configuration is the same except that the reference numerals are changed from 300s to 500s, a description thereof will be omitted.

### [Functional Configuration of Language Processing Device]

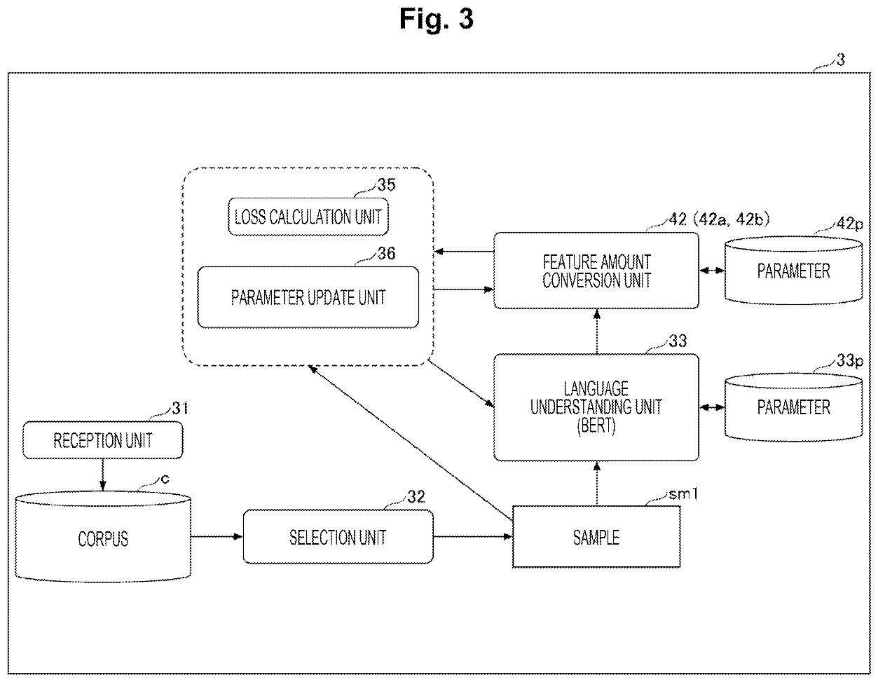

Next, a functional configuration of the language processing device will be described with reference to FIG. 3.

### <Functional Configuration of Learning Phase of Training Data>

FIG. 3 is a functional configuration diagram of a learning phase of training data of the language processing device. In FIG. 3, the language processing device 3 includes a reception unit 31, a selection unit 32, a language understanding unit (BERT) 33, a loss calculation unit 35, a parameter update unit 36, and a linear conversion layer 42. Each of these units corresponds to a function to be realized by a command by the processor 301 of FIG. 2 based on a program.

Further, the memory 302 or the auxiliary storage device 303 of FIG. 2 stores a corpus c, a parameter 33p of the language understanding unit, and a parameter 42p of the linear conversion layer 42.

The reception unit 31 receives a plurality of pieces of training data (a set of an input X and an answer Y) from the outside, and inputs the training data as the corpus c.

The selection unit 32 selects one piece of data (an input X and an answer Y) as a processing target from the plurality of pieces of training data as the corpus c. Note that the answer Y includes three labels of a start point of the answer, an end point of the answer, and an answer possibility. The first two labels are collectively referred to as a correct answer section, and the rest label is referred to as a correct answer possibility.

The language understanding unit 33 vectorizes a text pattern of the text data (input X), and extracts a feature amount of the text data. As a neural network model of the language understanding unit 33, for example, bidirectional encoder representations from transformers (BERT) is used.

Specifically, the language understanding unit 33 divides the text data into predetermined words, sets, as an input X, a word in a state of being expressed as a word vector, inputs the input X to the neural network, and converts the input X into H, which is a feature amount represented by the following formula, based on a model parameter.

$$H = ( {h}_{0} , … , {h}_{L} ) ∈ {ℝ}^{L \times d} \qquad [ Math . 1 ]$$

d is a dimension of an intermediate representation, and L is a text length and is the number of tokens when the input X is divided into tokens that are predetermined processing units. Note that, in the present embodiment, the token that is the predetermined processing unit is indicated as “word” and that the numbers from 0 to L when words included in the text data are sequentially arranged from the beginning are indicated as “positions of words”. Note that the token needs to be matched with the processing unit of the language model and is generally a sub-word in a case where BERT is used.

The loss calculation unit 35 calculates a loss function value based on output data of the feature amount conversion unit 42.

The parameter update unit 36 updates the parameters 33p and 42p based on the output data from the loss calculation unit 35.

The feature amount conversion unit 42 linearly converts the feature amount acquired from the language understanding unit 33 by using the parameter 42p of the linear conversion layer. The feature amount conversion unit 42 will be described in detail later.

In an extraction-type machine reading task, one or two (linear conversion layers 42a and 42b) conversion layers are prepared as the feature amount conversion unit 42.

One linear conversion layer 42a is represented by the following formula.

$${Lìnear}_{Ans} ( H ) = ( S ; E ) ∈ {ℝ}^{L \times 2} \qquad [ Math . 2 ]$$

The following formula represents a score at which the word at each position is a start point of the answer.

$$S ∈ {ℝ}^{L} \qquad [ Math . 3 ]$$

The following formula represents a score at which the word at each position is an end point of the answer.

$$E ∈ {ℝ}^{L} \qquad [ Math . 4 ]$$

On the other hand, the other linear conversion layer 42b is represented by the following formula.

$${Linear}_{NoAns} ( {h}_{0} ) = NA ∈ {ℝ}^{2} \qquad [ Math . 5 ]$$

The other linear conversion layer 42b is prepared only in a case where it is desired to consider answer possibility. Dimensions of NA represent an answer possibility score and an answer impossibility score.

In learning of the training data, learning of S, E, and NA is performed with a cross entropy loss. All the parameters 33p and 42p which are learned in the learning phase of the training data are fixed.

### <Functional Configuration of Learning Phase of Development Data>

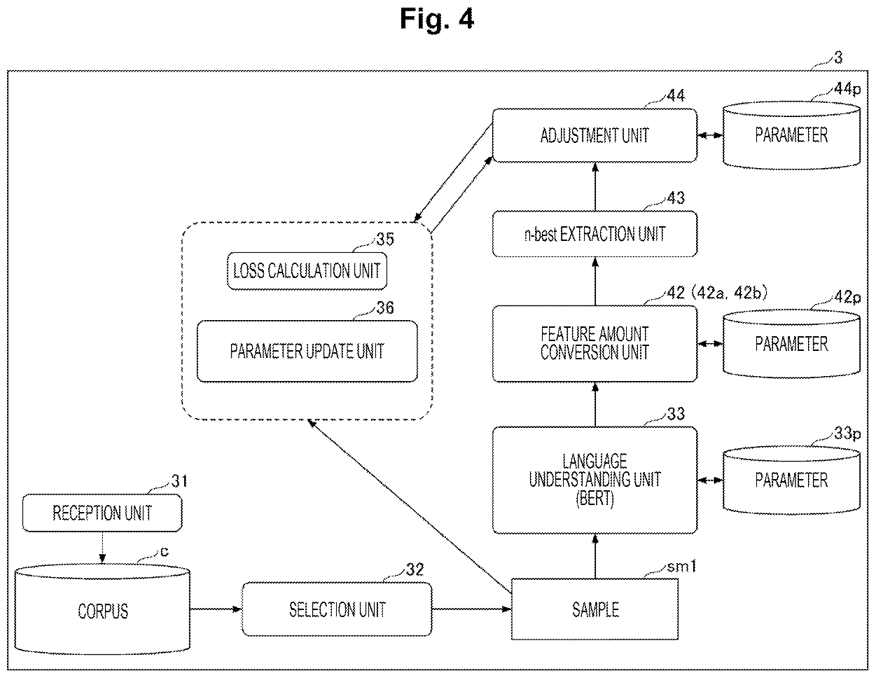

FIG. 4 is a functional configuration diagram of a learning phase of development data of the language processing device. In FIG. 4, the language processing device 3 includes a selection unit 32, a language understanding unit (BERT) 33, a loss calculation unit 35, a parameter update unit 36, a feature amount conversion unit 42, an n-best extraction unit 43, and an adjustment unit 44. Each of these units corresponds to a function to be realized by a command by the processor 301 of FIG. 2 based on a program.

Further, the memory 302 or the auxiliary storage device 303 of FIG. 2 stores a corpus c, a parameter 33p of the language understanding unit, a parameter 42p of the feature amount conversion unit 42, and a parameter 44p of the adjustment unit 44. Note that the functional configuration similar to the functional configuration of the learning phase of the training data is denoted by the same reference numerals, and a description thereof will be omitted.

In the learning phase of the development data, temperature scaling is used for output of the linear conversion layer 42a (Linear_{Ans}), and biased temperature scaling is used for output of the linear conversion layer 42b (Linear_{NoAns}). This is because the number of answer impossibility data and the number of answer possibility data are unbalanced. Here, temperature scaling and biased temperature scaling are used for description. On the other hand, any calibration method as introduced in <Reference Literature 1> can also be used.

### <Reference Literature 1> on Calibration of Modern Neural Networks

The n-best extraction unit 43 extracts, as feature amounts of an answer possibility, a feature amount of the start point and a feature amount of the end point by extracting predetermined n answer sections among feature amounts of each text data based on an answer start point score and an answer end point score which are output from the feature amount conversion unit 42. For the answer section, the start point and the end point may be determined such that the start point is located before the end point by using the formula 3, the formula 4, and an answer suitability score. The answer suitability score is a value based on the start point score and the end point score. For example, the answer suitability score is indicated by a sum or a product of the start point score and the end point score. In the present embodiment, the sum in formula 13 is used. As an example of extraction of the n answer sections, there is a case where n feature amounts are extracted in descending order of the answer suitability score. In addition, an arbitrary extraction method can be used. For example, in a case where an extracted answer possibility shares a word with a higher answer possibility, an extraction method such as ignoring the answer possibility may be adopted. A section corresponding to a unique expression extracted by an external unique expression extraction tool or the like may be adopted as a negative example. In training, extraction of the n answer sections should always include a true answer (answer Y).

The temperature scaling executed by the adjustment unit 44 is a method of adding a temperature parameter represented by the following formula and multiplying the score x by 1/T.

$$T ∈ ℝ \qquad [ Math . 6 ]$$

When converting the score x into a probability distribution, softmax conversion represented by the following formula is performed.

$$\frac{{e}^{{x}_{i}}}{{\sum }_{j} {e}^{{x}_{j}}} \qquad [ Math . 7 ]$$

Therefore, by setting the score to 1/T, a flat probability distribution is obtained when T is large, and a steep probability distribution is obtained when T is small. By setting T to a large value, an overconfidence phenomenon can be suppressed. i and j are positions of words to be answered, and i and j are arbitrary integers from 1 to L.

The biased temperature scaling executed by the adjustment unit 44 is a method of adding a temperature parameter represented by the following formula 8 and a bias parameter represented by the following formula 9 and calculating a score represented by the following formulas 10 and 11.

$$T ∈ ℝ \qquad [ Math . 8 ]$$

$$B ∈ {ℝ}^{k} \qquad [ Math . 9 ]$$

$$x ∈ {ℝ}^{k} \qquad [ Math . 10 ]$$

$$\frac{x}{T} + B \qquad [ Math . 11 ]$$

Here, k is the number of labels. In the linear conversion layer 42b (Linear_{NoAns}), k=2. The presence of the bias parameter B makes it possible to treat labels equally even in imbalanced data.

In the present embodiment, first, for the linear conversion layer 42b represented by the following formula, narrowing down is performed by the n-best extraction unit 43.

$${Linear}_{Ans} ( H ) = ( S ; E ) ∈ {ℝ}^{L \times 2} \qquad [ Math . 12 ]$$

It is assumed that a true start point is iₜᵣᵤₑ and a true end point is jₜᵣᵤₑ. For the start point i and the end point j, it is assumed that the answer suitability score is sᵢ+eⱼ.

The true answer suitability score is represented by the following formula.

$${a}_{true} = {s}_{{i}_{true}} + {e}_{{j}_{true}} \qquad [ Math . 13 ]$$

The answer suitability score can also be calculated for a negative example by the following formula.

$${a}_{{nega}_{1}} , … , {a}_{{nega}_{n - 1}} \qquad [ Math . 14 ]$$

A vector in which these n scores are arranged is an answer suitability score vector represented by the following formula.

$$A ∈ {ℝ}^{n} \qquad [ Math . 15 ]$$

The negative example is an answer possibility other than the true answer selected by the n-best extraction unit 43.

Next, the adjustment unit 44 performs temperature scaling on the obtained answer suitability score vector A. A temperature parameter T_{A} is prepared, and a cross entropy loss is calculated using A/T_{A} as a score. The only learnable parameter related to the loss is the temperature parameter T_{A}. Since T_{A} scales the score equally for all labels, a label which reaches a maximum value does not change before and after learning, and the output answer does not change. By the temperature scaling, the model performs learning of the scale T_{A} such that an adjusted answer suitability score, which is an output probability distribution represented by the following formula, matches with a probability that the output is actually true.

$$softmax ( A / {T}_{A} ) \qquad [ Math . 16 ]$$

Further, for the answer possibility score which is an output of the linear conversion layer 42b and is represented by the following formula, a temperature parameter T_{NA} and a bias parameter B_{NA} are prepared, and a cross entropy loss is calculated.

$${Linear}_{NoAns} ( {h}_{0} ) = NA \qquad [ Math . 17 ]$$

The learning parameters related to the loss are only the T_{NA} and the B_{NA}. Since the biased temperature scaling uses the bias parameter, an output answer may change before and after learning. The model performs learning of the scale and the bias such that an adjusted answer possibility score represented by the following formula matches with a probability that the output is actually true.

$$softmax ( \frac{NA}{{T}_{NA}} + {B}_{NA} ) \qquad [ Math . 18 ]$$

In learning of the development data, a gradient is calculated using a sum of these two cross entropy losses as a loss function, and a model is learned.

In addition, as a secondary effect of the bias parameter, the output of the label when performing inference can be set to a label having a maximum score. In a case where there is no bias parameter, it is necessary to manually set a threshold value, such as outputting of the answer possibility only when, for example, a probability that an answer can be made is equal to or higher than 0.7.

### <Functional Configuration of Inference Phase of Test Data>

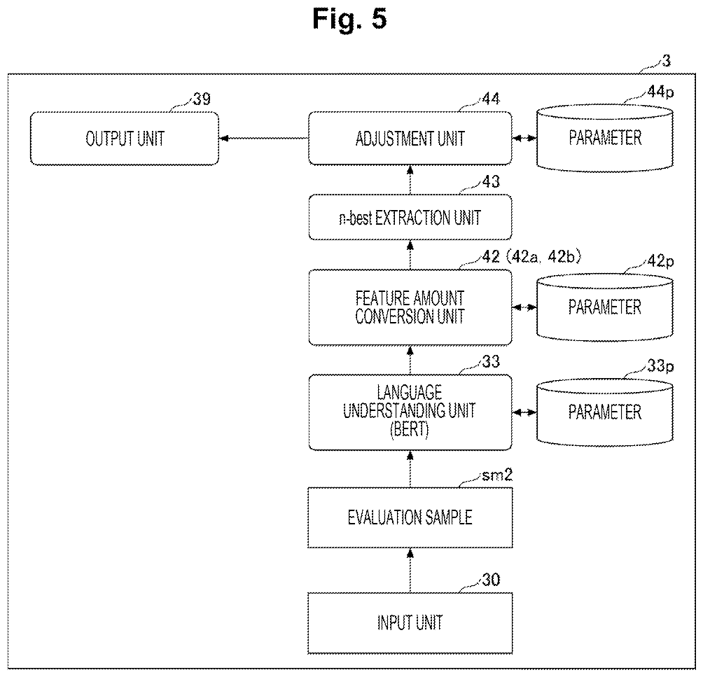

FIG. 5 is a functional configuration diagram of an inference phase of test data of the language processing device. In FIG. 5, the language processing device 3 includes a language understanding unit (BERT) 33, a feature amount conversion unit 42, an n-best extraction unit 43, an adjustment unit 44, and an output unit 39. Each of these units corresponds to a function to be realized by a command by the processor 301 of FIG. 2 based on a program.

Further, the memory 302 or the auxiliary storage device 303 of FIG. 2 stores a parameter 33p of the language understanding unit, a parameter 42p of the feature amount conversion unit 42, and a parameter 44p of the adjustment unit 44. Note that the functional configuration similar to the functional configuration of the learning phase of the training data and the functional configuration of the learning phase of the development data is denoted by the same reference numerals, and a description thereof will be omitted.

In the inference phase, the output unit 39 calculates a predicted answer and predicted answer reliability by using the adjusted answer suitability score and the adjusted answer possibility score which are output by the adjustment unit 44. Specifically, the predicted answer and the predicted answer reliability are defined by a section that reaches a maximum of the following formula and a maximum value of the section.

$$softmax ( A / {T}_{A} ) ∈ {ℝ}^{n} \qquad [ Math . 19 ]$$

In addition, a predicted answer possibility (output of answer possibility or answer impossibility) and reliability of the predicted answer possibility are defined by a component that reaches a maximum of the following formula and a maximum value the component.

$$softmax ( \frac{NA}{{T}_{NA}} + {B}_{NA} ) ∈ {ℝ}^{2} \qquad [ Math . 20 ]$$

Finally, the output unit 39 outputs, as result data, the predicted answer, the predicted answer reliability, the predicted answer possibility, and the reliability of the predicted answer possibility.

### Processing or Operation According to Embodiment

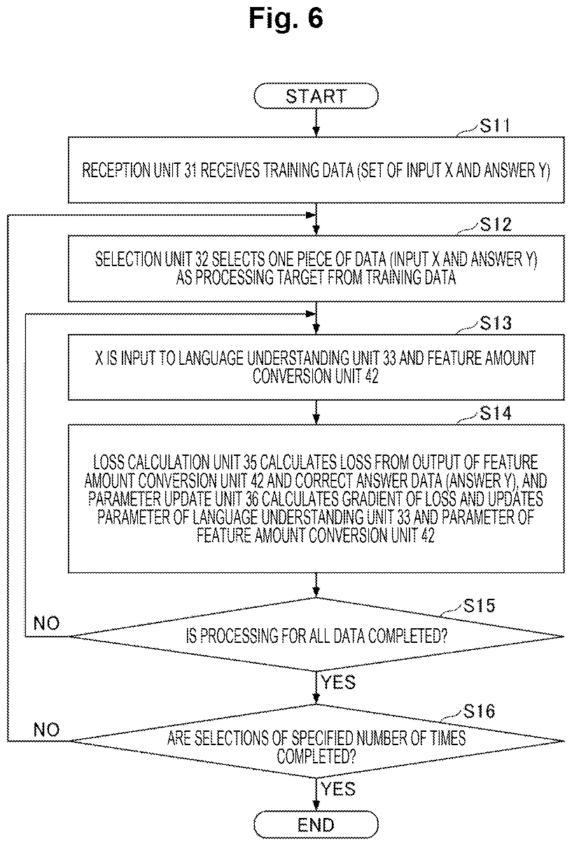

Next, processing or an operation according to the present embodiment will be described in detail with reference to FIG. 6 to FIG. 9. Note that the description is divided into a learning phase of training data, a learning phase of development data, and an inference phase of test data.

### <Outline of Processing or Operation>

As described above, it is generally known that a deep learning model has a problem of overconfidence. That is, a probability p(m) that a label m which is output from an identification-type deep learning model is true tends to be higher than a probability that m is actually true. This overconfidence phenomenon is a big problem when reliability of output is presented to a user.

For this reason, general ways to deal with the overconfidence phenomenon are as follows.

First, a model is learned using training data, and parameters are fixed. Next, some parameters are added to the model, and the added parameters are learned using development data. A purpose of this learning is to match a probability distribution which is output by the model with a probability that the output of the model is actually true.

There are various methods for configuring parameters to be added, and a method called temperature scaling has been known to be simple and have high performance (Reference Literature 1).

In addition, as a method in a case where the number of pieces of data of each label is unbalanced, there is (biased) temperature scaling (Reference Literature 2).

<Reference Literature 2> Calibration with Bias-Corrected Temperature Scaling Improves Domain Adaptation Under Label Shift in Modern Neural Networks

Further, as a measure for a large number of answer possibilities in extraction-type machine reading, narrowing down to n-best is performed. That is, learning and inference are performed on {true answer, negative example 1, . . . , negative example n-1} instead of a probability distribution on label sets {1, . . . , L}×{1, . . . , L}.

### <Learning Phase of Training Data>

Next, a learning phase of training data will be described with reference to FIG. 6. FIG. 6 is a flowchart illustrating processing of a learning phase of training data.

First, the reception unit 31 receives training data (a set of an input X and an answer Y) from the outside (S11).

The selection unit 32 selects one piece of data (an input X and an answer Y) as a processing target from a plurality of pieces of training data (S12).

In addition, data of the input X is sequentially input to the language understanding unit 33 and the feature amount conversion unit 42, and the above-described processing is performed in each unit (S13).

The loss calculation unit 35 calculates a loss from output of the feature amount conversion unit 42 and correct answer data Y that is an answer, and the parameter update unit 36 calculates a gradient of the loss and updates the parameter 33p of the language understanding unit 33 and the parameter 42p of the linear conversion layer 42 (S14).

Next, the selection unit 32 determines whether or not processing of step S13 and step S14 is completed for all the data by the operations so far (S15). In addition, in a case where processing of all the data is not completed (NO in step S15), the process returns to step S13. On the other hand, in a case where processing of all the data is completed, the selection unit 32 determines whether or not repeated operations of step S12 to step S15 are completed a specified number of times (S16). In addition, in a case where the repeated operations are not completed the specified number of times (NO in S16), all the data is regarded as unprocessed data, and the process returns to step S12. On the other hand, in a case where the repeated operations are completed the specified number of times (YES in step S16), all the processing of the learning phase of the training data is ended.

### <Learning Phase of Development Data>

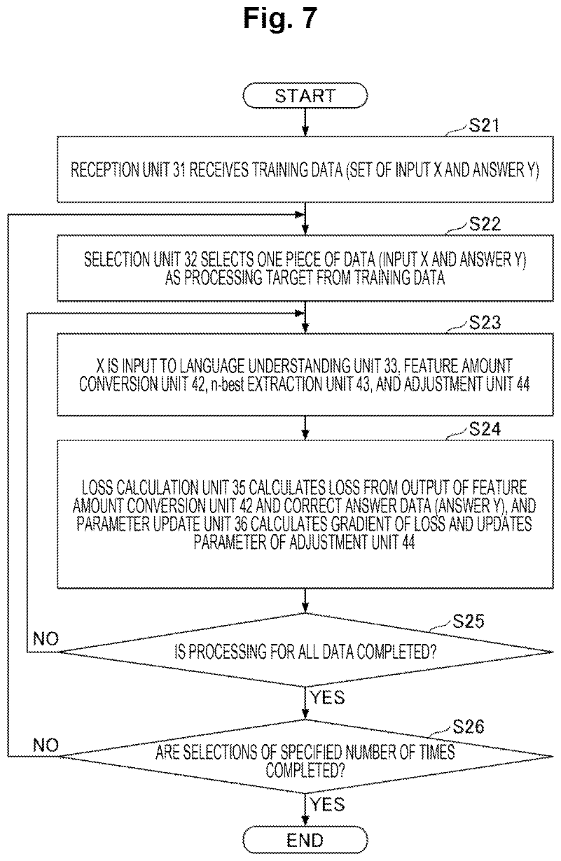

Next, a learning phase of development data will be described with reference to FIG. 7. FIG. 7 is a flowchart illustrating processing of a learning phase of development data.

First, the reception unit 31 receives training data (a set of an input X and an answer Y) from the outside (S21).

The selection unit 32 selects one piece of data (an input X and an answer Y) as a processing target from a plurality of pieces of training data (S22).

In addition, the selection unit 32 sequentially inputs data of the input X to the language understanding unit 33, the feature amount conversion unit 42, the n-best extraction unit 43, and the adjustment unit 44, and the above-described processing is performed in each unit (S23).

The loss calculation unit 35 calculates a loss from output of the adjustment unit 44 and correct answer data Y that is an answer, and the parameter update unit 36 calculates a gradient of the loss and updates the parameter 44p of the adjustment unit (S24).

Next, the selection unit 33 determines whether or not processing of step S23 and step S24 is completed for all the data by the operations so far (S25). In addition, in a case where processing of all the data is not completed (NO in step S25), the process returns to step S23. On the other hand, in a case where processing of all the data is completed, the selection unit 32 determines whether or not repeated operations of step S22 to step S25 are completed a specified number of times (S26). In addition, in a case where the repeated operations are not completed the specified number of times (NO in S26), all the data is regarded as unprocessed data, and the process returns to step S22. On the other hand, in a case where the repeated operations are completed the specified number of times (YES in step S26), all the processing of the learning phase of the development data is ended.

### <Inference Phase of Test Data>

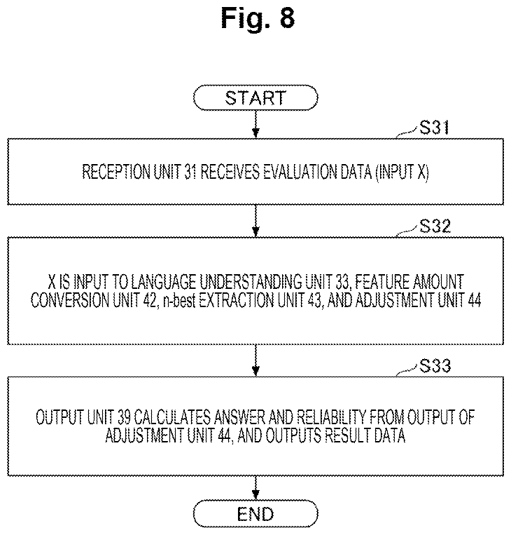

Finally, an inference phase of the test data will be described with reference to FIG. 8. FIG. 8 is a flowchart illustrating processing of an inference phase of test data.

First, the input unit 30 receives, as an evaluation sample sm2, an input of evaluation data (input X) (S31).

Next, data of the input X is sequentially input to the language understanding unit 33, the feature amount conversion unit 42, the n-best extraction unit 43, and the adjustment unit 44, and the above-described processing is performed in each unit (S32).

Next, the output unit 39 calculates an answer and reliability from the output of the adjustment unit 44, and outputs result data (S33).

### Evaluation Example

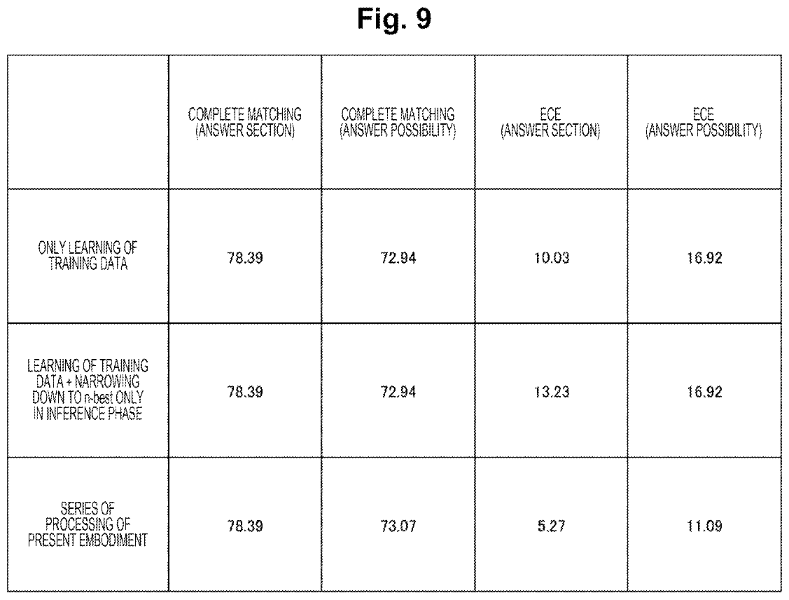

Subsequently, an evaluation example using the language processing device according to the present embodiment will be described. FIG. 9 is a diagram illustrating evaluation results.

In this evaluation, SQuAD 2.0 data sets are evaluated by using 90% random data of official training data as training data, the 10% remaining data as development data, and official development data as test data.

In this evaluation example, in the negative example extraction method in training and the answer possibility extraction method in inference, a sample having a highest answer suitability score a is selected. For n, 3 is used. In addition, the temperature parameter T is set to T=exp (T′) where T′ is a parameter of an implemented model. This is because the temperature parameter needs to take a positive value.

As an evaluation measure of the answer itself, a complete matching rate of labels of answer impossibility and answer possibility and a complete matching rate of answer sections in a case where an answer can be made are used. In addition, as an evaluation measure of reliability, an expected calibration error (ECE) is used. Specifically, calculation is performed as follows.

It is assumed that a probability which is output by the model for a sample x is p(x)∈[0, 1]. Next, [0, 1] is divided by 10. For example, for division [0, 0.1], an average of p(x) is calculated for a set of all samples satisfying p(x)∈[0, 0.1]. The average is an average of reliability in the division [0, 0.1]. In addition, a complete matching rate of the model output is calculated for the sample set. The complete matching rate is an actual correct answer rate in the division [0, 0.1]. A value obtained by taking an absolute value of a difference between the average of reliability and the actual correct answer rate in each division and taking a micro average for the division is an ECE value. Since the ECE value corresponds to an expected value of a difference between the reliability of the model output and the actual correct answer rate, it is preferable that the ECE value has a small value.

There are three comparison methods: a method in which the language processing device 3 of FIG. 3 performs learning of the training data and outputs the reliability by a normal method; a method in which the language processing device 3 of FIG. 3 similarly performs learning of the training data, performs narrowing down to n-best only in the inference phase, and outputs the reliability; and a series of processing according to the present embodiment. Note that, in the series of processing according to the present embodiment, in both the learning phase and the inference phase, narrowing down to n-best is executed and biased temperature scaling and temperature scaling are executed. In all the methods, a threshold value for determination of the answer possibility is set to 0.5. That is, the label having a high score is output.

The results are shown in a table of FIG. 9. All units are %. The present embodiment improves the ECE without impairing the complete matching rate for the answer section. The ECE deteriorates in a case where the reliability based on n-best is simply applied to the model. On the other hand, in the present embodiment, the reliability based on n-best is also used in learning, and this contributes to improvement of the ECE. For the answer possibility, the presence of the bias parameter slightly improves the complete matching rate. It is found that the ECE is also improved.

### [Main Advantageous Effects of Embodiment]

As described above, according to the present embodiment, the language processing device 3 performs temperature scaling (biased temperature scaling) on the identification-type deep learning model in the extraction-type machine reading, and performs learning after narrowing down to n-best. Therefore, a probability distribution which is output by the model can be approximated to a probability that the label is actually true. Thereby, the present embodiment has an effect that the reliability of prediction can be more appropriately calculated as compared with the technique in the related art.

### [Supplements]

The present invention is not limited to the above-described embodiment, and the following configuration or processing (operation) may be used.

Although the language processing device 3 can be realized by a computer and a program, the program can also be provided by being recorded in a (non-transitory) recording medium or via a communication network 100.

### [Appendixes]

The above-described embodiment can also be expressed as the following inventions.

### [Appendix 1]

A language processing device including a processor,
wherein the processor is configured to:
extract a feature amount from text data based on model parameters of a neural network;
receive, as an input, the feature amount based on the model parameters of the neural network and output an answer start point score, an answer end point score, and an answer possibility score;
extract predetermined n answer suitability scores based on the answer start point score and the answer end point score;
obtain n adjusted answer suitability scores from the n answer suitability scores based on the model parameters of the neural network, and obtain an adjusted answer possibility score from the answer possibility score based on the model parameters of the neural network; and
perform learning of the model parameters based on the n adjusted answer suitability scores, the adjusted answer possibility score, a correct answer section, and a correct answer possibility.

### [Appendix 2]

The language processing device according to Appendix 1,
wherein, in extraction of the n answer suitability scores, the processor is configured to extract the n answer suitability scores in descending order of scores.

### [Appendix 3]

The language processing device according to Appendix 1 or 2,
wherein the n adjusted answer suitability scores and the adjusted answer possibility score are obtained based on biased temperature scaling and temperature scaling by the neural network.

### [Appendix 4]

A language processing device including a processor,
wherein the processor is configured to:
extract a feature amount from text data based on model parameters of a neural network, the model parameters being learned in advance;
receive, as an input, the feature amount based on the model parameters of the neural network and output an answer start point score, an answer end point score, and an answer possibility score, the model parameters being learned in advance;
extract predetermined n answer suitability scores based on the answer start point score and the answer end point score;
obtain n adjusted answer suitability scores from the n answer suitability scores based on the model parameters of the neural network, and obtain an adjusted answer possibility score from the answer possibility score based on the model parameters of the neural network, the model parameters being learned in advance; and
calculate a predicted answer, predicted answer reliability, predicted answer possibility, and reliability of predicted answer possibility from the n adjusted answer suitability scores and the adjusted answer possibility score.

### [Appendix 5]

A language processing method executed by a language processing device, the method including:
a language understanding step of extracting a feature amount from text data;
a feature amount conversion step of receiving the feature amount as an input and outputting an answer start point score, an answer end point score, and an answer possibility score;
an n-best extraction step of extracting predetermined n answer suitability scores based on the answer start point score and the answer end point score; and
an adjustment step of obtaining n adjusted answer suitability scores from the n answer suitability scores, and obtaining an adjusted answer possibility score from the answer possibility score,
wherein, in the language understanding step, the feature amount conversion step, and the adjustment step, processing based on model parameters of a neural network is performed, and
learning of the model parameters is performed based on the n adjusted answer suitability scores, the adjusted answer possibility score, a correct answer section, and a correct answer possibility.

### [Appendix 6]

A non-transitory recording medium storing a program for causing a computer to execute the method according to Appendix 5.

### REFERENCE SIGNS LIST

1 Communication system
3 Language processing device
5 Communication terminal
30 Input unit
31 Reception unit
32 Selection unit
33 Language understanding unit
35 Loss calculation unit
36 Parameter update unit
39 Output unit
42 Feature amount conversion unit
43 n-best extraction unit
44 Adjustment unit

1. A language processing device comprising:
a hardware processor configured to
extract a feature amount from text data based on model parameters of a neural network;
output an answer start point score, an answer end point score, and an answer possibility score using the feature amount as an input, based on model parameters of the neural network;
extract predetermined n answer suitability scores based on the answer start point score and the answer end point score;
obtain n adjusted answer suitability scores from the n answer suitability scores and obtain an adjusted answer possibility score from the answer possibility score, based on model parameters of the neural network;
learn the model parameters based on the n adjusted answer suitability scores, the adjusted answer possibility score, a correct answer section, and a correct answer possibility.

2. The language processing device according to claim 1,
wherein the hardware processor is configured to extract the n answer suitability scores in descending order of scores.

3. The language processing device according to claim 1,
wherein the hardware processor is configured to obtain the n adjusted answer suitability scores and the adjusted answer possibility score based on biased temperature scaling and temperature scaling.

4. A language processing device comprising:
a hardware processor configured to
extract a feature amount from text data based on model parameters of a neural network that are learned in advance;
output an answer start point score, an answer end point score, and an answer possibility score using the feature amount as an input, based on model parameters of the neural network that are learned in advance;
extract predetermined n answer suitability scores based on the answer start point score and the answer end point score;
obtain n adjusted answer suitability scores from the n answer suitability scores and obtain an adjusted answer possibility score from the answer possibility score; and
calculate a predicted answer, predicted answer reliability, predicted answer possibility, and reliability of predicted answer possibility from the n adjusted answer suitability scores and the adjusted answer possibility score,
wherein the hardware processor is configured to extract the feature amount and output the answer start point score, the answer end point score, and the answer possibility score, based on the n answer suitability scores, the answer possibility score, a correct answer section, and a correct answer possibility.

5. A communication system comprising:
the language processing device according to claim 1; and
a communication terminal that receives result data from the language processing device via a communication network.

6. A language processing method executed by a language processing device, the method comprising:
extracting a feature amount from text data based on model parameters of a neural network;
outputting an answer start point score, an answer end point score, and an answer possibility score using the feature amount as an input, based on model parameters of the neural network;
extracting predetermined n answer suitability scores based on the answer start point score and the answer end point score;
obtaining n adjusted answer suitability scores from the n answer suitability scores and obtaining an adjusted answer possibility score from the answer possibility score, based on model parameters of the neural network; and
learning the model parameters based on the n adjusted answer suitability scores, the adjusted answer possibility score, a correct answer section, and a correct answer possibility.

7. A non-transitory computer-readable recording medium storing a program for causing a computer to execute the method according to claim 6.
